(19) United States
(12) Patent Application Publication
(10) Pub. No.: US 2011/0266254 A1
(43) Pub. Date: Nov. 3, 2011

(54) Method of Manufacturing Textile Fabric Article

(76) Inventor: Miles Stephen Cain, Derbyshire (GB)

(21) Appl. No.: 13/127,766

(22) PCT Filed: Nov. 5, 2008
(86) PCT No.: PCT/GB2008/003728

§ 371 Date: Jul. 20, 2011

(51) Int. Cl. B32B 37/02; B32B 37/10; B32B 38/00; B32B 37/14; B32B 38/04; B32B 41/00; B32B 37/06; B32B 37/12

(52) U.S. Cl. 216/34; 156/275.5; 156/229; 156/267; 156/380.9; 156/357

(57) ABSTRACT

A method of manufacturing a textile fabric article comprises the steps of: (i) applying an uncured silicone elastomer (10) requiring UV radiation to trigger curing thereof to at least one portion of a carrier element (12); (ii) feeding the carrier element (12) and a piece of textile fabric (14) between movable co-acting compression members (16,18) so that the uncured silicone elastomer (10) is located between the carrier element (12) and the piece of textile fabric (14); (iii) exposing the uncured silicone elastomer (10) on the carrier element (12) to UV radiation upstream of the co-acting compression members (16,18); (iv) curing the uncured silicone elastomer (10) or allowing the uncured silicone elastomer (10) to cure to bond the silicone elastomer (10) to at least the piece of textile fabric (14); and (v) applying pressure to the carrier element (12) and the piece of textile fabric (14) via the co-acting compression members (16,18) for at least part of the curing process.

The invention relates particularly, but not exclusively, to a method of manufacturing a textile fabric article.

During the manufacture of garments and other textile fabric articles sewing is conventionally used to finish edges of fabric, create hems and seams, and to generally secure components of textile fabric articles together. However the use of sewing results in the creation of stitches, which are often undesirable in the fashion industry and can create discomfort in garments where the stitches lay directly against a wearer's skin. Consequently, so as to improve the aesthetic appearance and, where appropriate, the comfort of textile fabric articles, it is becoming increasingly desirable to use adhesives as an alternative to sewing.

One such method includes the use of polyurethane film which is laid between pieces of textile fabric and heated so as to melt the film. The melted film then sets so as to adhere to the pieces of textile fabric and thereby adheres the pieces of textile fabric together. However a drawback with the use of polyurethane film resides in the fact that, once set, the film locks the individual yarns in the pieces of textile fabric in place. As a consequence the set film inhibits the natural stretch of the textile fabric, which is undesirable in the manufacture of stretchable textile fabric articles.

Other methods include the use of adhesive elastomers, which are more likely to permit a textile fabric to retain its natural stretch. However a drawback associated with the use of adhesive elastomers resides in the need to cure the adhesive elastomer following application to a piece of textile fabric so as to bond the adhesive elastomer to the textile fabric, and difficulties associated with controlling the commencement of the curing process and the rate of curing.

According to a first aspect of the invention there is provided a method of manufacturing a textile fabric article comprising the steps of:
(i) applying an uncured silicone elastomer requiring UV radiation to trigger curing thereof to at least one portion of a carrier element;
(ii) feeding the carrier element and a piece of textile fabric between movable co-acting compression members so that the uncured silicone elastomer is located between the carrier element and the piece of textile fabric;
(iii) exposing the uncured silicone elastomer on the carrier element to UV radiation upstream of the co-acting compression members;
(iv) curing the uncured silicone elastomer or allowing the uncured silicone elastomer to cure to bond the silicone elastomer to at least the piece of textile fabric; and
(v) applying pressure to the carrier element and the piece of textile fabric via the co-acting compression members for at least part of the curing process.

The use of an uncured silicone elastomer requiring UV radiation to trigger curing ensures the silicone elastomer does not start to cure until it is exposed to UV radiation and thereby provides a means for controlling commencement of the curing process. This in turn allows a user to ensure the silicone elastomer does not begin to cure until after it is applied to the textile fabric.

The application of pressure for at least part of the curing process ensures that the silicone elastomer bonds to at least the piece of textile fabric.

Preferably pressure is applied to the carrier element and the piece of textile fabric via the co-acting compression members until a bond is created between the silicone elastomer and at least the piece of textile fabric.

This ensures that on removal of the pressure the silicone elastomer cannot easily be pulled away from at least the piece of textile fabric.

Preferably the bond between the silicone elastomer and at least the piece of textile fabric is created within five seconds; more preferably within two seconds; and most preferably within one second.

In such embodiments curing of the silicone elastomer continues after removal of the pressure to further increase the strength of the bond between the silicone elastomer and at least the piece of textile fabric.

The ongoing curing of the silicone elastomer preferably occurs under ambient conditions but, in other embodiments, may be facilitated by placing the carrier element and the piece of textile fabric into a heated press or an oven.

In other embodiments curing of the silicone elastomer is completed before removal of the pressure.

In order to apply pressure to the carrier element and the piece of textile fabric one of the co-acting compression members may include a roller engageable against a compression surface defined on the other of the co-acting compression members, the compression members being movable to co-act to define a nip through which the carrier element and the piece of textile fabric are fed.

In such embodiments, the co-acting compression members may include a pair of co-acting rollers.

The use of one or a pair of rollers allows the carrier element and the piece of textile fabric to be drawn through the nip defined by the co-acting compression members.

In particularly preferred embodiments using one or more rollers, the or at least one of the rollers may be driven to draw the carrier element and the piece of textile fabric between the co-acting compression members.

In other embodiments, in order to apply pressure to the carrier element and the piece of textile fabric, one of the co-acting compression members may include a belt engageable against a compression surface defined on the other of the co-acting compression members, the compression members being movable to co-act to define a nip through which the carrier element and the piece of textile fabric are fed.

In such embodiments, the co-acting compression members may include a pair of co-acting belts.

The use of one or a pair of belts again allows the carrier element and the piece of textile fabric to be drawn through the nip defined by the co-acting compression members.

In particularly preferred embodiments using one or more belts, the or at least one of the belts may be driven to draw the carrier element and the piece of textile fabric between the co-acting compression members.

Preferably one of the co-acting compression members is movable relative to the other of the co-acting compression members to allow location of the carrier element and the piece of textile fabric therebetween.

In order to initiate curing of the silicone elastomer, the uncured silicone elastomer may be exposed to UV radiation immediately upstream of the nip defined between the co-acting compression members. This ensures that curing of the silicone elastomer does not commence until immediately prior to the silicone elastomer being pressed against the piece of textile fabric and thereby ensures maximum bonding of the silicone elastomer with the piece of textile fabric.

In embodiments where the piece of textile fabric is stretchable, the piece of textile fabric may be provided in a taut condition, the tension being maintained until a bond is created between the silicone elastomer and the piece of textile fabric. This allows the creation of a ruched effect in the piece of textile fabric.

In embodiments where the carrier element is to be secured to the piece of textile fabric the curing process bonds the silicone elastomer to both the piece of textile fabric and the carrier element.

The carrier element in such embodiments may include a length of elasticated fabric or a silicone tape, either of which may be provided in a taut condition such that maintenance of the tension until a bond is created between the silicone elastomer and each of the carrier element and the piece of textile fabric creates a ruched effect in the piece of textile fabric.

This allows, for example, the creation of a stretchable and/or shaped opening or edge to a garment.

The carrier element in other such embodiments may include a textile trim element, another piece of textile fabric or a non-textile element.

In one other such embodiment, the pieces of textile fabric may be first and second portions of the same piece of textile fabric, the uncured silicone elastomer being applied to the first portion, which is then folded onto the second portion before the first and second portions are fed in face to face contact, with the silicone elastomer located therebetween, between the movable co-acting compression members. This allows the creation of a half-turn hem.

The method may then be repeated with the piece of textile fabric being folded again after the application of the uncured silicone elastomer to one portion and prior to the step of feeding between the co-acting compression members in order to create a full hem.

The ability to create a half-turn or full hem in the manner permits the creation of a hem in which the textile fabric retains its ability to stretch. In addition the elastic resilience of the cured elastomer improves the fabric's ability to resume its structure following stretch.

In another such embodiment, the other piece of textile fabric may be another panel of a garment. In such an embodiment the uncured silicone elastomer may be applied along the edge of a first of the pieces of textile fabric before being arranged relative to the other of the pieces of textile fabric so as to sandwich the uncured silicone elastomer between the edges of the panels such that the silicone elastomer adheres the edges of the panels together and therefore creates a seam between the panels.

In embodiments where the carrier element is to be secured to the piece of textile fabric the step of applying the uncured silicone elastomer to the carrier element preferably involves controlling the extent to which the uncured silicone elastomer penetrates the carrier element.

This improves any mechanical bond created between the silicone elastomer and the carrier element following completion of the curing process and thereby reduces the risk of the carrier element peeling away from the cured silicone elastomer in embodiments where the composition of the silicone elastomer is chosen to favour mechanical bonding over chemical bonding.

The extent to which the uncured silicone elastomer penetrates the carrier element may be controlled by one or more of the following:
(i) the application of pressure to the carrier element following application of the uncured silicone elastomer;
(ii) varying the quantity of uncured silicone elastomer applied to the carrier element; and
(iii) varying the rate at which the uncured silicone elastomer cures.

In embodiments where the carrier element is to be secured to the piece of textile fabric the extent to which the silicone elastomer adheres to the carrier element following curing of the silicone elastomer may be improved by preconditioning a receiving surface of the carrier element prior to the step of applying the uncured silicone elastomer to the receiving surface of the carrier element.

Preconditioning of the receiving surface may include the application of a chemical primer to the receiving surface, etching the receiving surface or brushing the receiving surface.

In other embodiments, the carrier element may be removable once a bond is created between the silicone elastomer and the piece of textile fabric or on completion of the curing process. In such embodiments, the carrier element serves to protect the silicone elastomer, and prevent the silicone elastomer adhering to one or other of the co-acting compression members, during the application of pressure via the co-acting compression members.

In such embodiments the carrier element may be a release paper or, in other embodiments, the carrier element may be a continuous belt following a cyclic path. The use of a continuous belt is advantageous in circumstances where it is desirable to provide a continuous length of silicone elastomer along a piece of textile fabric since it provides a continuous means for transferring and applying the uncured silicone elastomer to the piece of textile fabric.

Following exposure of the uncured silicone elastomer to UV radiation, the silicone elastomer may be allowed to cure under ambient conditions. A relatively high rate of cure is however desirable in the manufacture of textile fabric articles in order to permit each step in the manufacturing process to be performed consecutively in a relatively short period of time, and preferably at the same work station.

The rate of curing of a silicone elastomer may be increased through the application of heat, the more heat energy that is applied to the silicone elastomer within a period of time the greater the rate of curing. Conventionally ovens have been used to supply sufficiently large quantities of heat energy in order to accelerate the rate of curing. However the use of an oven does not lend itself to the manufacture of a textile fabric article at a single work station.

In order to increase the rate of curing of the silicone elastomer without the need for an oven, the uncured silicone elastomer may be heated prior to its application to the carrier element. Pre-heating the uncured silicone elastomer accelerates curing of the silicone elastomer once it is exposed to UV radiation and thereby allows a user to achieve a higher rate of cure than would otherwise be achieved unless the carrier element and the piece of textile fabric were heated during the curing process.

The use of an uncured silicone elastomer requiring UV radiation to trigger curing allows for pre-heating of the uncured silicone elastomer since it ensures the uncured silicone elastomer does not start to cure until after it is exposed to UV radiation.

In such embodiments the carrier element may also be heated prior to the step of applying the uncured silicone elastomer to the carrier element. This reduces the possibility of the carrier element absorbing heat from the uncured silicone element once it is applied to the carrier element and thereby maximizes the heat energy present in the silicone elastomer once the silicone elastomer is exposed to UV radiation.

In order to further increase the rate of curing of the silicone elastomer once it is exposed to UV radiation, heat may be applied to the silicone elastomer following exposure of the uncured silicone elastomer to UV radiation by means of heated elements such as, for example, heated plates, heated rollers and/or heat lamps.

Depending on the composition of the adhesive, the application of an adhesive onto a piece of textile fabric can lead to adjacent yarns of the textile fabric becoming chemically adhered to one another following curing of the adhesive. In such circumstances, adjacent yarns are unable to move relative to one another, thereby rigidifying the piece of textile fabric and restricting the ability of the piece of textile fabric to stretch.

By altering the composition of the adhesive, it is possible to reduce the degree of chemical bonding outlined above and produce a less rigid, mechanical bond in which the adhesive penetrates the piece of textile fabric so as to surround the yarns without chemically adhering the yarns to one another. In such circumstances, adjacent yarns are able to move relative to one another, thereby leading to a more flexible piece of textile fabric that is able to stretch whilst maintaining its structure by virtue of the presence of the cured adhesive.

However, increasing the degree of mechanical bonding presents its own problems in that the absence of chemical bonding between adjacent yarns means that the adhesive is more easily pulled away from the textile fabric, and is therefore prone to peel away from the textile fabric once it is cured.

Preferably therefore an uncured silicone elastomer constituted from two or more mixable parts is used so as to permit variance of the physical properties of the silicone elastomer following completion of the curing process.

This allows a user, in dependence on the nature of the textile fabric, to control the degree of chemical versus mechanical bonding following curing of the elastomer and therefore allows a user to impart desirable physical characteristics, such as a particular elastic modulus or a particular friction generating quality, to the silicone elastomer following completion of the curing process.

The relative proportions of the respective mixable parts of the uncured silicone elastomer are preferably chosen immediately prior to the step of applying the uncured silicone elastomer to the carrier element fabric so as to impart desirable physical properties to the silicone elastomer following completion of the curing process.

The relative proportions of the respective mixable parts of the uncured silicone elastomer may then be varied during the step of applying the uncured silicone elastomer to the carrier element so as to impart varying physical properties to the silicone elastomer following completion of the curing process.

This allows the creation of a continuous region of cured elastomer in which one area has more mechanical or chemical bonding than areas immediately adjacent thereto. This can be particularly advantageous in circumstances where the silicone elastomer is prone to peel away from the piece of textile fabric following curing as a result of a high degree of mechanical bonding or due to the structure of the piece of textile fabric. This is because it allows the provision of discrete regions of silicone elastomer having high degrees of chemical bonding following curing to securely bond the silicone elastomer to the piece of textile fabric.

In order to vary the adhesive properties of the silicone elastomer following completion of the curing process, one or more mixable parts may be an adhesive promoter.

The uncured silicone elastomer is preferably applied in the form of a liquid.

The use of a liquid silicone is advantageous in that it facilitates good penetration of the textile fabric, produces good elastic properties following completion of the curing process and facilitates pumping and mixing of the uncured silicone elastomer.

In other embodiments, where less penetration is required and the elastic properties of the elastomer following completion of the curing process are less important, the uncured silicone elastomer may be applied in the form of a paste.

In a preferred embodiment, the step of feeding the carrier element and a piece of textile fabric between the co-acting compression members so that the uncured silicone elastomer is located between the carrier element and the piece of textile fabric involves positioning the carrier element relative to the piece of textile fabric so that on removal of the pressure the silicone elastomer is bonded to at least the piece of textile fabric along a defined path and the method further includes the step of trimming the textile fabric following removal of the pressure so as to shape the piece of textile fabric in accordance with the path of the bond between the silicone elastomer and the piece of textile fabric.

In such embodiments, on completion of the curing process, the silicone elastomer fixes the edge of the trimmed piece of textile fabric so as to prevent fraying whilst allowing the trimmed textile fabric to retain its ability to stretch according to the needs of a user.

According to a second aspect of the invention there is provided an apparatus for manufacturing a textile fabric article comprising:
(i) an applicator to apply, in use, an uncured silicone elastomer requiring UV radiation to trigger curing thereof to a carrier element, the applicator including a darkened supply passage to prevent irradiation of the uncured silicone elastomer to UV radiation prior to application of the uncured silicone elastomer to the carrier element;
(ii) a pair of movable co-acting compression members to apply pressure to the carrier element and a piece of textile fabric arranged, in use, between the co-acting compression members so that the uncured silicone elastomer is located between the carrier element and the piece of textile fabric; and
(iii) a UV light source to irradiate the uncured silicone elastomer upstream of the co-acting compression members, following application of the uncured silicone elastomer and prior to the application of pressure to the carrier element and the piece of textile fabric.

So as to increase the rate of curing of the uncured silicone elastomer after its exposure to UV radiation, the apparatus may further include one or more heat sources to heat the uncured silicone elastomer upstream of the applicator and/or downstream of the UV light source.

The nature and combination of heat sources are preferably determined by the rate of curing required.

So as to minimize wastage of silicone elastomer the apparatus may further include:
(a) a feed assembly upstream of the co-acting compression members to feed the piece of textile fabric towards the co-acting compression members;
(b) sensors associated with the feed assembly to determine the position of the piece of fabric relative to the co-acting compression members; and
(c) a controller to control the applicator and thereby control the application of uncured silicone elastomer to the carrier element in dependence on the position of the piece of fabric relative to the co-acting compression members.

This arrangement allows a user to control the feeding of the piece of textile fabric and the application of the uncured silicone elastomer to the carrier element so as to ensure that applicator does not commence the application of uncured silicone elastomer until the piece of fabric is located a predetermined distance from the co-acting compression members and so that the carrier element carrying silicone elastomer thereby meet immediately upstream of the co-acting compression members.

Other advantageous features of the apparatus are defined in the dependent claims.

Embodiments of the various aspects of the invention will now be described by way of non-limiting examples with reference to the accompanying drawings in which:

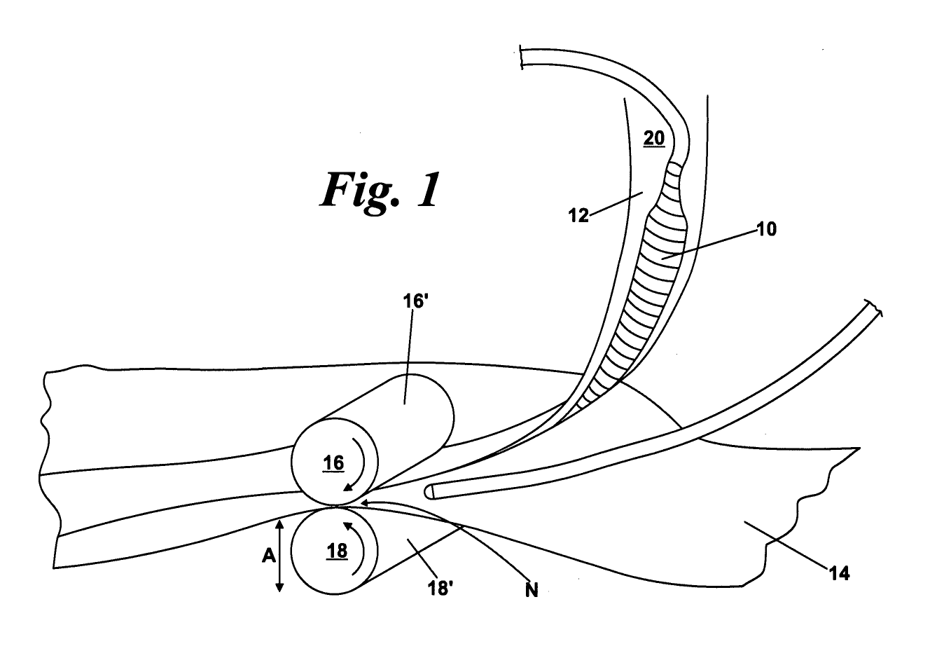

FIG. 1 illustrates steps of a method according to an embodiment of the invention;

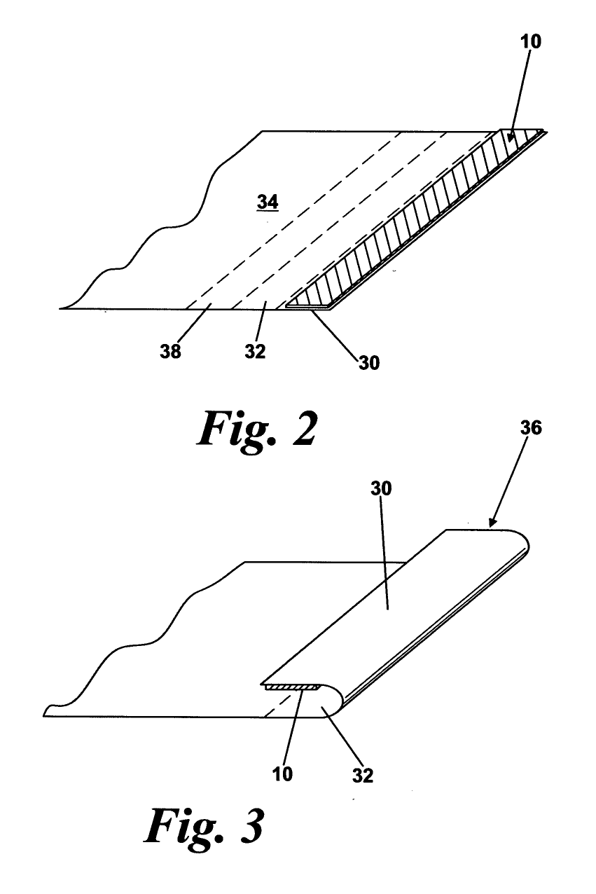

FIGS. 2 and 3 illustrate steps of a method according to another embodiment of the invention;

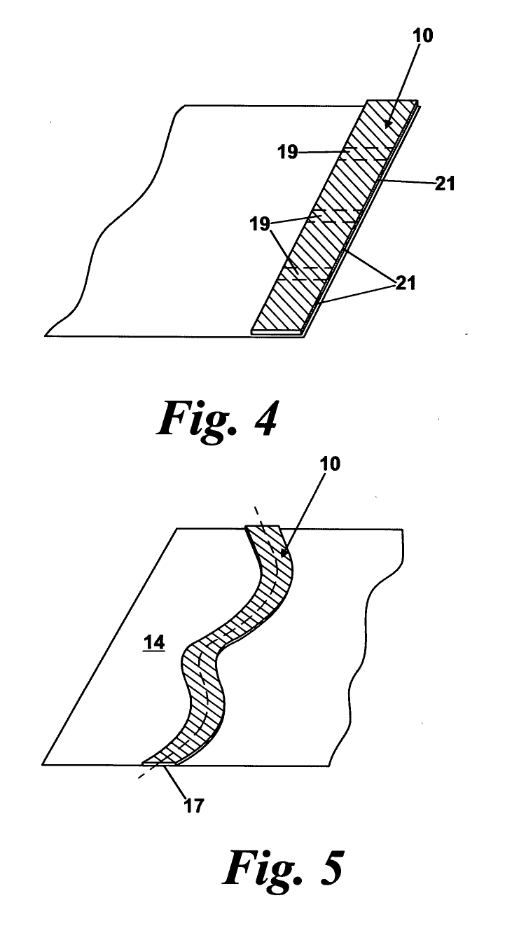

FIG. 4 illustrates steps of a method according to a further embodiment of the invention;

FIG. 5 illustrates steps of a method according to a yet further embodiment of the invention;

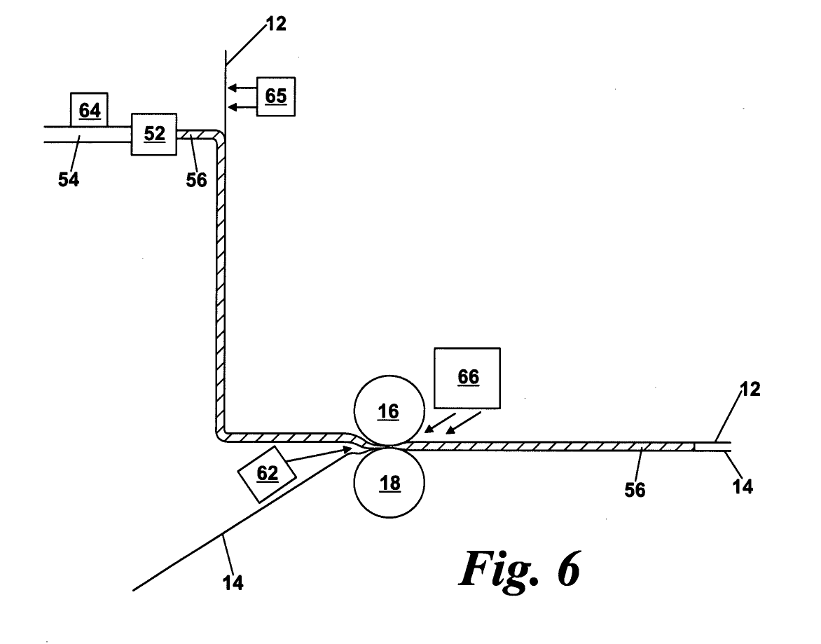

FIG. 6 shows a schematic illustration of an apparatus according to an embodiment of the invention; and

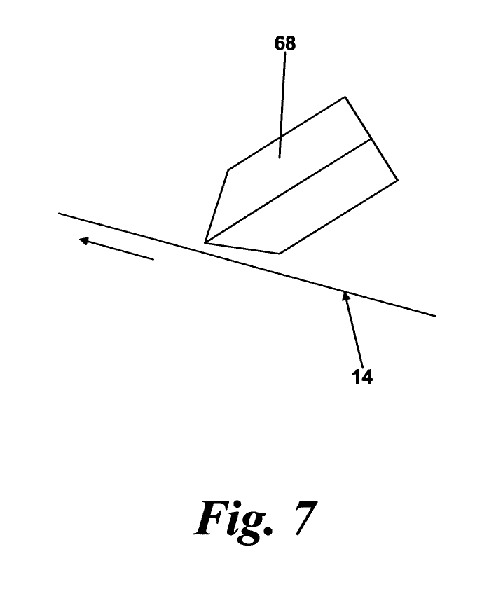

FIG. 7 illustrates an applicator and controller according to a yet further embodiment of the invention.

A method of manufacturing a textile fabric article according to an embodiment of the invention is illustrated in FIG. 1.

The method involves the step of applying an uncured silicone elastomer 10 requiring UV radiation to trigger curing thereof to a carrier element, which in the embodiment shown in FIG. 1 is provided in the form of a textile trim element 12.

In the embodiment shown in FIG. 1 the uncured silicone elastomer 10 is applied in the form of a liquid. In other embodiments it is envisaged that it may be applied in the form of a paste.

The textile trim element 12 is then fed with a piece of textile fabric 14 between movable co-acting compression members so that the uncured silicone elastomer 10 is located between the textile trim element 12 and the piece of textile fabric 14. The textile fabric may be a knitted of woven fabric, or part of a seamless or paneled garment or a hosiery leg.

The method further involves the step of exposing the uncured silicone elastomer 10 to UV radiation upstream of the co-acting compression members so as to trigger curing of the uncured silicone elastomer 10.

Once curing of the silicone elastomer 10 is triggered, the silicone elastomer 10 is allowed to cure and the co-acting compression members apply pressure to the textile trim element 12 and the piece of textile fabric 14 for at least part of the curing process.

In the embodiment shown in FIG. 1, the co-acting compression members are a pair of co-acting rollers 16,18, a compression surface 18′ on one of the rollers 18 being engageable against a corresponding compression surface 16′ defined on the other of the rollers 16.

The rollers 16,18 define a nip N through which the textile trim element 12 and the piece of textile fabric 14 are fed. One of the rollers 18 is movable towards and away from the other of the rollers 16, as depicted by arrow A, to allow location of the textile trim element 12 and the piece of textile fabric 14 therebetween.

In the embodiment shown in FIG. 1, each of the co-acting rollers 16,18 is driven to rotate so as to draw the textile trim element 12 and the piece of fabric 14 through the nip N.

In other embodiments of the invention it is envisaged that one of the rollers may be replaced by a fixed support defining a compression surface against which the other of the rollers engages.

In yet further embodiments of the invention it is envisaged that one or both of the rollers 16,18 may be replaced by a belt drive element.

The uncured silicone elastomer 10 is exposed to UV radiation immediately upstream of the nip N defined between the co-acting rollers 16,18. This ensures that curing of the silicone elastomer 10 does not commence until immediately prior to the application of pressure to the textile trim element 12, the silicone elastomer 10 and the piece of textile fabric 14 and thereby ensures maximum bonding of the silicone elastomer 10 with the textile trim element 12 and the piece of textile fabric 14.

In the embodiment shown in FIG. 1, the UV radiation is directed into an envelope defined between the textile trim element 12 and the piece of textile fabric 14 to irradiate the uncured silicone elastomer 10.

In other embodiments it is envisaged that the UV radiation may be directed from either above or below the textile trim element 12 and the piece of textile fabric 14 so as to irradiate the uncured silicone elastomer 10 through either the textile trim element 12 or the piece of textile fabric 14.

The size of the rollers 16,18 and the speed at which they are driven to rotate is chosen so that the nip N of the rollers 16,18 applies pressure to the textile trim element 12 and the piece of textile fabric 14 until a bond is created between the silicone elastomer 10 and each of the textile trim element 12 and the piece of textile fabric 14.

This ensures that when the textile trim element 12 and the piece of textile fabric 14 exit the nip N of the rollers 16,18 the silicone elastomer 10 cannot easily be pulled away from either the textile trim element 12 or the piece of fabric 14.

The bond between the silicone elastomer 10 and each of the textile trim element 12 and the piece of textile fabric 14 is preferably formed with 5 seconds, more preferably within 2 seconds and most preferably within 1 second.

Curing of the silicone elastomer 10 continues after removal of the pressure otherwise provided by the nip N of the rollers 16,18 so as to further increase the strength of the bond between the silicone elastomer 10 and each of the textile trim element 12 and the piece of textile fabric 14.

In other embodiments it is envisaged that the curing process may be complete before the textile trim element 12 and the piece of textile fabric 14 exit the nip N of the rollers 16,18.

In the embodiment shown in FIG. 1, the curing of the silicone elastomer occurs at ambient room temperature and the ongoing curing also occurs at ambient room temperature. It may therefore take a number of hours for the curing process to complete.

In other embodiments the rate of the ongoing curing may be increased by placing the textile trim element 12 and the piece of textile fabric 14, with the silicone elastomer 10 sandwiched therebetween, into a heated press or an oven.

In further embodiments of the invention, the rate of curing of the silicone elastomer may be increased by pre-heating the uncured silicone elastomer 10 prior to its application to the textile trim element 12. Following exposure of the uncured silicone elastomer 10 with UV radiation, the heat present in the silicone elastomer 10 accelerates the rate of curing thereof.

In such embodiments the textile trim element 12 may also be heated prior to the step of applying the uncured silicone elastomer 10 to the textile trim element 12. This reduces the possibility of the textile trim element 12 absorbing heat from the uncured silicone elastomer 10 once it is applied to the textile trim element 12 and thereby maximizes the heat present in the silicone elastomer 10 once it is exposed to UV radiation.

In yet further embodiments of the invention, the rate of curing of the silicone elastomer 10 may be increased by heating the textile trim element 12, the silicone elastomer 10 and the piece of textile fabric 14 following irradiation of the silicone elastomer 10 with UV radiation. Such heating may be performed by means of heat lamps and/or heated plates.

The extent to which the silicone elastomer 10 adheres to the textile trim element 12 may be improved by preconditioning a receiving surface 20 of the textile trim element 12 prior to the step of applying the uncured silicone elastomer 10. Such preconditioning may include the application of a chemical primer to the receiving surface 20, etching the receiving surface 20 or brushing the receiving surface 20.

The use of a silicone elastomer 10 to bond the textile trim element 12 to the piece of textile fabric 14 permits the textile trim element 12 and the piece of textile fabric 14 to retain their natural ability to stretch and return to their original shape.

The extent to which the piece of textile fabric 14 and the textile trim element 12 retain their natural ability to stretch following completion of the curing process is determined by the composition of uncured silicone elastomer 10, which in turn determines the degree of mechanical versus chemical bonding of the silicone elastomer 10 with the piece of textile fabric 14 and the textile trim element 12 on completion of the curing process.

So as to vary the physical properties of the silicone elastomer 10 following completion of the curing process, the uncured silicone elastomer 10 is preferably formed from three mixable parts, one of those parts including an adhesion promoter.

It is envisaged that in other embodiments, the uncured silicone elastomer 10 may be formed from one part. The uncured silicone elastomer 10 may also be formed from two mixable parts. In such embodiments, one part may be the uncured silicone elastomer and the other part may be an adhesion promoter.

In a particularly preferred embodiment of the invention, the relative proportions of the respective mixable parts of the uncured silicone elastomer 10 are chosen immediately prior to the step of applying the uncured silicone elastomer 10 to the textile trim element 12 depending on the structures of the textile trim element 12 and the piece of textile fabric 14, and the desired physical characteristics of the silicone elastomer 10 following completion of the curing process.

The relative proportions of the respective mixable parts are preferably variable during the step of applying the uncured silicone elastomer 10 so as to impart varying physical properties to the silicone elastomer once it is cured. This allows the creation of a continuous region of silicone elastomer in which discrete regions 19 have a higher degree of chemical bonding to regions 21 located either side thereof, as illustrated schematically in FIG. 4.

In order to improve any mechanical bond created between the silicone elastomer 10 and each of the textile trim element 12 and the piece of textile fabric 14 following completion of the curing process, the extent to which the uncured silicone elastomer 10 penetrates the textile trim element 12 and the piece of textile fabric 14 is controlled.

Such control may be achieved by controlling the depth to which the uncured silicone elastomer 10 is applied to the textile trim element 12. Preferably the depth of the uncured silicone elastomer 10 is in the region of 0.1 mm-10.0 mm.

Such control may also be achieved by scraping the uncured silicone elastomer 10 into the textile trim element 12 following its application and prior to its exposure to UV radiation.

Controlling the depth of the uncured silicone elastomer 10 on the textile trim element 12 in turn controls the extent to which the silicone elastomer 10 penetrates the piece of textile fabric 14.

Control may also be achieved by varying the rate at which the silicone elastomer 10 cures. As will be appreciated, the longer the silicone elastomer 10 takes to cure the deeper into each of the textile trim element 12 and the piece of textile fabric 14 the silicone elastomer 10 is likely to penetrate.

In another embodiment where the textile trim element 12 is a stretchable member such as, for example, a strip of elasticated textile fabric or a length of cured silicone tape, the method may further include the step of tensioning the textile trim element 12 prior to feeding it between the rollers 16,18 with the piece of textile fabric 14. The tension is maintained until a bond is created between the silicone elastomer and each of the textile trim element 12 and the piece of fabric 14. This creates a ruched effect in the piece of textile fabric 14 and allows the creation of a stretchable and/or shaped opening or edge to a garment, for example.

In other embodiments, where for example the piece of textile fabric 14 is stretchable, tension may be maintained in the piece of textile fabric until a bond is created between the silicone elastomer and each of the textile trim element 12 and the piece of fabric 14.

In other embodiments, the carrier element may be provided in the form of another piece of textile fabric such as another panel of a garment or article. The method according to the invention thereby allows the creation of a seam between the pieces of textile fabric.

In embodiments where the pieces of textile fabric are first and second portions 30,32 of the same piece of textile fabric 34, the uncured silicone elastomer 10 is applied to the first portion 30, as illustrated in FIG. 2. The first portion 30 is then folded onto the second portion 32, as illustrated in FIG. 3, before the first and second portions 30,32 are fed in face to face contact through the nip N of the rollers 16,18 with the silicone elastomer 10 located therebetween.

In such an embodiment, the first and second portions 30,32 of the piece of textile fabric 34 are exposed to UV radiation immediately prior to being fed between the rollers 16,18, the UV radiation penetrating the first and second portions 30,32 so as to initiate curing of the silicone elastomer 10.

Curing of the silicone elastomer 10 creates a bond between the silicone elastomer 10 and each of the first and second portions 30,32 of the piece of textile fabric 34 and thereby secures the half-turn hem 36.

In order to form a full hem, this method is repeated and uncured silicone elastomer 10 is applied to the opposite side of the first portion 30 of the piece of textile fabric 34. The piece of textile fabric 34 is then folded so as to sandwich the uncured silicone elastomer 10 between the opposite side of the first portion 30 of the piece of textile fabric 34 and a third portion 38 of the piece of textile fabric 34 to define a full hem. The full hem is then exposed to UV radiation, which penetrates the piece of textile fabric 34 so as to trigger curing of the uncured silicone elastomer 10 before the full hem is fed through the nip N of the co-acting rollers 16,18.

In yet further embodiments, the carrier element may be provided in the form of a release paper or a continuous belt.

In such embodiments, the silicone elastomer 10 does not form a bond with the carrier element and the carrier element is removed once a bond is created between the silicone elastomer and the piece of textile fabric 14 or when the curing process is complete.

The use of a removable carrier element is advantageous in circumstances where it is desirable to create a stretchable fabric article through the application of a silicone elastomer directly onto the surface of the piece of textile fabric 14.

The carrier element transfers the silicone elastomer 10 onto the surface of the piece of textile fabric 14 and protects the silicone elastomer 10 while the carrier element and the piece of textile fabric 14 are fed through the nip N of the rollers 16,18 in that it prevents the silicone elastomer 10 adhering to the roller 16 into which it would otherwise come into contact.

In yet further embodiments, where the carrier element is provided in the form of either an element intended to be bonded to a piece of textile fabric 14 or a removable element, the step of feeding the carrier element and the piece of textile fabric 14 through the nip N of the co-acting rollers 16,18 may involve positioning of the carrier element relative to the piece of textile fabric so that when the carrier element and the piece of textile fabric 14 exit the nip N of the rollers 16,18, the silicone elastomer 10 is bonded to at least the piece of textile fabric 14 along a defined path 17, as illustrated schematically in FIG. 5.

The method may then include the step of trimming the piece of textile fabric 14 along the defined path so as to shape the piece of textile fabric 14 in accordance with the path of the bond between the silicone elastomer 10 and the piece of textile fabric 14.

In such embodiments, the silicone elastomer 10 fixes the edge of the trimmed piece of textile fabric 14 so as to prevent fraying whilst allowing the trimmed textile fabric 14 to retain its ability to stretch.

Apparatus 50 for manufacturing a textile fabric article according to an embodiment of the invention is illustrated in FIG. 6.

The apparatus 50 includes an applicator 52 including a darkened supply passage 54 for applying an uncured silicone elastomer 56 requiring UV radiation to trigger curing to a carrier element 12. The apparatus 50 also includes a pair of movable, co-acting rollers 16,18 to apply pressure to the carrier element 12 and a piece of textile fabric 14 arranged between the co-acting rollers 16,18.

The apparatus 50 also includes a UV light source 62 to irradiate the uncured silicone elastomer 56 following application of the uncured silicone elastomer 56 and prior to the application of pressure to the carrier element 12 and the piece of textile fabric 14 so as to trigger curing of the uncured silicone elastomer to bond the silicone elastomer to at least the piece of textile fabric 14.

The provision of the darkened supply passage 54 in the applicator 52 prevents the uncured silicone elastomer 56 being irradiated with UV radiation prior to its application to the textile fabric. This in turn ensures that the silicone elastomer 56 does not cure within the supply passage 54, which could cause a blockage in the supply passage 54.

The apparatus 50 also includes a heat source 64 upstream of the applicator 52 to heat the uncured silicone elastomer 56 before it is applied to the textile fabric 60, a heat source 65 to heat the carrier element 12 and a heat source 66 downstream of the applicator 52 to heat the silicone elastomer 56 during curing.

In other embodiments of the invention, the darkened supply passage 54 may include a plurality of tubes, each tube carrying one of a plurality of mixable parts of the uncured silicone elastomer 56. The darkened supply passage 54 may also include a controller to control the amounts of the respective mixable parts that are mixed together prior or during application of the uncured silicone elastomer 56.

In further embodiments of the invention, the apparatus 50 may include a driven feed roller (not shown) arranged upstream of the rollers 16,18 and arranged to feed the piece of textile fabric 14 towards the nip N of the rollers 16,18.

Sensors are associated with the driven feed roller to determine the position of the piece of fabric 14 relative to the nip N of the rollers 16,18 so as to control the applicator 52 and thereby control the application of uncured silicone elastomer 10 to the carrier element 12. This control allows a user to control the feeding of the piece of textile fabric 14 and the application of the uncured silicone elastomer to the carrier element 12 so that the applicator 52 only starts to apply uncured silicone elastomer 10 to the carrier element 12 when the piece of textile fabric 14 is determined to be a predetermined distance from the nip N of the rollers 16,18. This allows a user to ensure that the piece of fabric 14 and the carrier element 12 carrying silicone elastomer 10 meet immediately upstream of the nip N of the rollers 16,18 and helps to minimize wastage of the silicone elastomer 10.

In further embodiments of the invention, where the carrier element 12 is a portion of the piece of fabric 14, the apparatus 50 may also include a folding device for folding the piece of textile fabric 14 following application of the uncured silicone elastomer so as to define a hem.

In yet further embodiments of the invention, the apparatus 50 may also include a controller in the form of a blade 68 (FIG. 7) arranged to scrape the uncured silicone elastomer into the textile fabric as it is applied so as to cause the uncured silicone elastomer to penetrate further into the textile fabric, and thereby assist in controlling the extent to which the uncured silicone elastomer penetrates into the textile fabric. In such embodiments, the speed at which the textile fabric and the applicator move relative to one another may be measurable so as to allow for the control of the rate at which the uncured silicone elastomer is applied, thereby helping to ensure that the correct amount and thickness of uncured silicone elastomer is applied.

In each of the embodiments described with reference to FIGS. 1-5, the textile fabric may be a knitted or woven textile fabric. The textile fabric may form part of a seamless garment, a paneled garment or a hosiery leg. It is also envisaged that the textile fabric may be a separate piece of textile fabric, not forming part of a garment, such as a length of elasticated fabric or lace, thereby permitting the production of lengths of silicone coated elastic or lace.

1. A method of manufacturing a textile fabric article comprising the steps of:
(i) applying an uncured silicone elastomer requiring UV radiation to trigger curing thereof to at least one portion of a carrier element;
(ii) feeding the carrier element and a piece of textile fabric between movable co-acting compression members so that the uncured silicone elastomer is located between the carrier element and the piece of textile fabric;
(iii) exposing the uncured silicone elastomer on the carrier element to UV radiation upstream of the co-acting compression members;
(iv) curing the uncured silicone elastomer or allowing the uncured silicone elastomer to cure to bond the silicone elastomer to at least the piece of textile fabric; and
(v) applying pressure to the carrier element and the piece of textile fabric via the co-acting compression members for at least part of the curing process.

2. A method of manufacturing a textile fabric article according to claim 1 wherein pressure is applied to the carrier element and the piece of textile fabric via the co-acting compression members until a bond is created between the silicone elastomer and at least a piece of textile fabric.

3. A method of manufacturing a textile fabric article according to claim 2 wherein the bond between the silicone elastomer and at least the piece of textile fabric within five seconds.

4. A method of manufacturing a textile fabric article according to claim 2 wherein the bond between the silicone elastomer and at least the piece of textile fabric within two seconds.

5. A method of manufacturing a textile fabric article according to claim 2 wherein the bond between the silicone elastomer and at least the piece of textile fabric within one second.

6. A method of manufacturing a textile fabric article according to claim 2 wherein the curing process continues after removal of the pressure to further increase the strength of the bond between the silicone elastomer and at least the piece of textile fabric.

7. A method of manufacturing a textile fabric article according to claim 2 wherein the curing process is completed prior to removal of the pressure.

8. A method of manufacturing a textile fabric article according to claim 1 wherein one of the co-acting compression members includes a roller engageable against a compression surface of the other of the co-acting compression members, the compression members being movable to co-act to define a nip through which the carrier element and the piece of textile are fed.

9. A method of manufacturing a textile fabric article according to claim 8 wherein the co-acting compression members include a pair of co-acting rollers.

10. A method of manufacturing a textile fabric article according to claim 8 wherein the or at least one roller is driven to draw the carrier element and the piece of textile fabric between the co-acting compression members.

11. A method of manufacturing a textile fabric article according to claim 1 wherein one of the co-acting compression members includes a belt engageable against a compression surface of the other of the co-acting compression members, the compression members being movable to co-act to define a nip through which the carrier element and the piece of textile are fed.

12. A method of manufacturing a textile fabric article according to claim 11 wherein the co-acting compression members include a pair of co-acting belts.

13. A method of manufacturing a textile fabric article according to claim 11 wherein the or at least one of the belts is driven to draw the carrier element and the piece of textile fabric between the co-acting compression members.

14. A method of manufacturing a textile fabric article according to claim 8 wherein one of the co-acting compression members is movable relative to the other of the co-acting compression members to allow location of the carrier element and the piece of textile fabric therebetween.

15. A method of manufacturing a textile fabric article according to claim 8 wherein the uncured silicone elastomer is exposed to UV radiation immediately upstream of the nip defined between the co-acting compression members.

16. A method of manufacturing a textile fabric article according to claim 1 wherein the piece of textile fabric is stretchable and is provided in a taut condition, the tension being maintained in the piece of textile fabric until a bond is created between the silicone elastomer and the piece of textile fabric.

17. A method of manufacturing a textile fabric article according to claim 1 wherein the step of curing the uncured silicone elastomer or allowing the uncured silicone elastomer to cure bonds the silicone elastomer to both the piece of textile fabric and the carrier element.

18. A method of manufacturing a textile fabric article according to claim 17 wherein the carrier element is provided in the form of a length of elasticated fabric or a silicone tape.

19. A method of manufacturing a textile fabric article according to claim 18 wherein the carrier element is provided in a taut condition, the tension being maintained in the carrier element until a bond is created between the silicone elastomer and each of the carrier element and the piece of textile fabric.

20. A method of manufacturing a textile fabric article according to claim 17 wherein the carrier element is a textile trim element, another piece of textile fabric or a non-textile element.

21. A method of manufacturing a textile fabric article according to claim 20 wherein the carrier element is another piece of textile fabric and the pieces of textile fabric are first and second portions of the same piece of textile fabric, the method further including the step of folding the first portion onto the second portion following the application of uncured silicone elastomer onto the first portion and before the first and second portions are fed between the co-acting compression members with the silicone elastomer sandwiched therebetween.

22. A method of manufacturing a textile fabric article according to claim 18 wherein the step of applying the uncured silicone elastomer to the carrier element involves controlling the extent to which the uncured silicone elastomer penetrates the carrier element.

23. A method of manufacturing a textile fabric article according to claim 22 wherein the extent to which the uncured silicone elastomer penetrates the carrier element is controlled by one or more of the following:
(a) the application of pressure to the carrier element following the step of applying the uncured silicone elastomer;
(b) varying the quantity of uncured silicone elastomer applied to the carrier element; and
(c) varying the rate at which the uncured silicone elastomer cures.

24. A method of manufacturing a textile fabric article according to claim 17 wherein a receiving surface of the carrier element is preconditioned prior to the step of applying the uncured silicone elastomer to the receiving surface of the carrier element.

25. A method of manufacturing a textile fabric article according to according to claim 24 wherein a chemical primer is applied to the receiving surface of the carrier element prior to the step of applying the uncured silicone elastomer to the receiving surface of the carrier element.

26. A method of manufacturing a textile fabric article according to claim 24 wherein the receiving surface of the carrier element is etched prior to the step of applying the uncured silicone elastomer to the receiving surface of the carrier element.

27. A method of manufacturing a textile fabric article according to claim 24 wherein the receiving surface of the carrier element is brushed prior to the step of applying the uncured silicone elastomer to the receiving surface of the carrier element.

28. A method of manufacturing a textile fabric article according to claim 1 wherein the carrier element is removable once a bond is created between the silicone elastomer and the piece of textile fabric or on completion of the curing process.

29. A method of manufacturing a textile fabric article according to claim 28 wherein the carrier element is provided in the form of a release paper.

30. A method of manufacturing a textile fabric article according to claim 28 wherein the carrier element is provided in the form of a continuous belt following a cyclic path.

31. A method of manufacturing a textile fabric article according to claim 1 further including the step of heating the uncured silicone elastomer prior to the step of applying the uncured silicone elastomer to the carrier element.

32. A method of manufacturing a textile fabric article according to claim 31 further including the step of heating the carrier element prior to step of applying the uncured silicone elastomer to the carrier element.

33. A method of manufacturing a textile fabric article according to claim 1 wherein the uncured silicone elastomer is heating during the curing process.

34. A method of manufacturing a textile fabric article according to claim 1 wherein the uncured silicone elastomer is constituted from two or more mixable parts.

35. A method of manufacturing a textile fabric article according to claim 34 wherein relative proportions of the respective mixable parts of the uncured silicone elastomer are chosen immediately prior to the step of applying the uncured silicone elastomer to the carrier element so as to impart desirable physical properties to the silicone elastomer following completion of the curing process.

36. A method of manufacturing a textile fabric article according to claim 35 wherein the relative proportions of the respective mixable parts of the uncured silicone elastomer are varied during the step of applying the uncured silicone elastomer to the carrier element so as to impart varying physical properties to the silicone elastomer following the completion of the curing process.

37. A method of manufacturing a textile fabric article according to claim 34 wherein one of the respective mixable parts of the uncured silicone elastomer is an adhesive promoter.

38. A method of manufacturing a textile fabric article according to claim 1 wherein the uncured silicone elastomer is applied in the form of a liquid.

39. A method of manufacturing a textile fabric article according to claim 1 wherein the uncured silicone elastomer is applied in the form of a paste.

40. A method of manufacturing a textile fabric article according to claim 1 wherein the step of feeding the carrier element and a piece of textile fabric between co-acting compression members so that the uncured silicone elastomer is located between the carrier element and the piece of textile fabric involves positioning the carrier element relative to the piece of textile fabric so that on removal of the pressure the silicone elastomer is bonded to at least the piece of textile fabric along a defined path and the method further includes the step of trimming the textile fabric following removal of the pressure so as to shape the piece of textile fabric in accordance with the path of the bond between the silicone elastomer and the piece of textile fabric.

41. Apparatus for manufacturing a textile fabric article comprising:
(i) an applicator to apply, in use, an uncured silicone elastomer requiring UV radiation to trigger curing thereof to a carrier element, the applicator including a darkened supply passage to prevent irradiation of the uncured silicone elastomer to UV radiation prior to application of the uncured silicone elastomer to the carrier element;
(ii) a pair of movable co-acting compression members to apply pressure to the carrier element and a piece of textile fabric arranged, in use, between the co-acting compression members so that the uncured silicone elastomer is located between the carrier element and the piece of textile fabric; and
(iii) a UV light source to irradiate the uncured silicone elastomer upstream of the co-acting compression members, following application of the uncured silicone elastomer and prior to the application of pressure to the carrier element and the piece of textile fabric.

42. Apparatus for manufacturing a textile fabric article according to claim 41 wherein one of the pair of co-acting compression members includes a roller engageable against a compression surface of the other of the co-acting compression members, the compression members co-acting to define a nip.

43. Apparatus for manufacturing a textile fabric article according to claim 42 wherein the co-acting compression members include a pair of co-acting rollers.

44. Apparatus for manufacturing a textile fabric article according to claim 42 wherein the or at least one of the rollers is driven.

45. Apparatus for manufacturing a textile fabric article according to claim 41 wherein one of the pair of co-acting compression members includes a belt engageable against a compression surface of the other of the co-acting compression members, the compression members co-acting to define a nip.

46. Apparatus for manufacturing a textile fabric article according to claim 45 wherein the co-acting compression members include a pair of co-acting belts.

47. Apparatus for manufacturing a textile fabric article according to claim 45 wherein the or at least one of the belts is driven.

48. Apparatus for manufacturing a textile fabric article according to claim 42 wherein one of the co-acting compression members is movable relative to the other of the co-acting compression members to allow location of the carrier element and the piece of textile fabric therebetween.

49. Apparatus for manufacturing a textile fabric article according to claim 42 wherein the UV light source is arranged to irradiate the uncured silicone elastomer immediately upstream of the nip defined between the co-acting compression members.

50. Apparatus for manufacturing a textile fabric article according to claim 41 further including a carrier element in the form of a continuous belt arranged to transfer, in use, uncured silicone elastomer from the applicator to the piece of textile fabric located between the co-acting compression members.

51. Apparatus for manufacturing a textile fabric article according to claim 41 further including one or more heat sources to heat the uncured silicone elastomer upstream of the applicator.

52. Apparatus for manufacturing a textile fabric article according to claim 51 further including one or more heat sources to heat the carrier element.

53. Apparatus for manufacturing a textile fabric article according to claim 41 further including one or more heat sources to heat the uncured silicone elastomer downstream of the applicator.

54. Apparatus for manufacturing a textile fabric article according to claim 41 further including a controller to control the extent to which the uncured silicone elastomer penetrates the carrier element.

55. Apparatus for manufacturing a textile fabric according to claim 41 further including a folding device to fold a first portion of a piece of textile fabric onto a second portion of the piece of textile fabric following the application of uncured silicone elastomer onto the first portion so as to sandwich the uncured silicone elastomer between the first and second portions of the piece of textile fabric.

56. Apparatus for manufacturing a textile fabric according to claim 41 further including:
(a) a feed assembly upstream of the co-acting compression members to feed the piece of textile fabric towards the co-acting compression members;
(b) sensors associated with the feed assembly to determine the position of the piece of fabric relative to the co-acting compression members; and
(c) a controller to control the applicator and thereby control the application of uncured silicone elastomer to the carrier element in dependence on the position of the piece of fabric relative to the co-acting compression members.
